(19) United States
(12) Patent Application Publication
(10) Pub. No.: US 2023/0177818 A1
(43) Pub. Date: Jun. 8, 2023

(54) AUTOMATED POINT-CLOUD LABELLING FOR LIDAR SYSTEMS

(71) Applicant: Sense Photonics, Inc., Durham, NC (US)

(72) Inventors: Sukesh Velayudhan Kaithakauzha, Fremont, CA (US); Ruifang Wang, San Francisco, CA (US); Sanket Rajendra Gujar, Palo Alto, CA (US)

(21) Appl. No.: 17/995,503

(22) PCT Filed: Apr. 5, 2021
(86) PCT No.: PCT/US2021/025832

§ 371 Date: Oct. 5, 2022

Related U.S. Application Data
(60) Provisional application No. 63/005,596, filed on Apr. 6, 2020.

(51) Int. Cl. G06V 10/82; G06T 7/62; G06V 10/764; G06V 20/64; G06T 7/194

(52) U.S. Cl. CPC G06V 10/82; G06T 7/62; G06V 10/764; G06V 20/64; G06T 7/194; G01S 17/894

(57) ABSTRACT

A Light Detection and Ranging (lidar) system includes a control circuit configured to receive three-dimensional (3D) point data and two-dimensional (2D) image data representing a field of view including a target object and an object volume prediction circuit configured to determine a predicted volume occupied by the target object within the 3D point data based on the 3D point data and the 2D image data.

### CLAIM OF PRIORITY

This application claims priority from U.S. Provisional Patent Application No. 63/005,596 filed Apr. 6, 2020, with the United States Patent and Trademark Office, the disclosure of which is incorporated by reference herein.

### FIELD

The present disclosure is directed to Light Detection and Ranging (LIDAR or lidar) systems, and more particularly, to methods and devices to detect objects in signal returns from lidar systems.

### BACKGROUND

Time of flight (ToF) based imaging is used in a number of applications including range finding, depth profiling, and 3D imaging (e.g., lidar). Direct time of flight measurement includes directly measuring the length of time between emitting radiation and sensing the radiation after reflection from an object or other target. From this, the distance to the target can be determined. Indirect time of flight measurement includes determining the distance to the target by phase modulating the amplitude of the signals emitted by emitter element(s) of the lidar system and measuring phases (e.g., with respect to delay or shift) of the echo signals received at detector element(s) of the lidar system. These phases may be measured with a series of separate measurements or samples. In specific applications, the sensing of the reflected radiation in either direct or indirect time of flight systems may be performed using an array of single-photon detectors, such as a Single Photon Avalanche Diode (SPAD) array. SPAD arrays may be used as solid-state detectors in imaging applications where high sensitivity and timing resolution are useful.

### SUMMARY

Some embodiments described herein provide methods, systems, and devices including electronic circuits to perform volume estimation in a lidar system based on two-dimensional (2D) data.

According to some embodiments of the present disclosure, a Light Detection and Ranging (lidar) system includes a control circuit configured to receive three-dimensional (3D) point data and two-dimensional (2D) image data representing a field of view including a target object and an object volume prediction circuit configured to determine a predicted volume occupied by the target object within the 3D point data based on the 3D point data and the 2D image data.

In some embodiments, the object volume prediction circuit is further configured to analyze the 2D image data utilizing a plurality of neural network models, wherein the plurality of neural network models are configured to generate respective 2D bounding boxes for the target object based on the 2D image data.

In some embodiments, the plurality of neural network models are further configured to generate respective object classifications for the target object based on the 2D image data.

In some embodiments, the object volume prediction circuit is further configured to generate a final bounding box based on the respective 2D bounding boxes of the plurality of neural network models.

In some embodiments, the object volume prediction circuit is further configured to generate the final bounding box based on an overlapping area between two or more of the respective 2D bounding boxes of the plurality of neural network models.

In some embodiments, the object volume prediction circuit is further configured to generate the final bounding box based on a deviation of the two or more of the respective 2D bounding boxes of the plurality of neural network models from the overlapping area.

In some embodiments, the neural network models comprise respective model bias scores, and the object volume prediction circuit is further configured to generate the final bounding box based on the respective model bias scores of the plurality of neural network models.

In some embodiments, the object volume prediction circuit is further configured to analyze the 2D image data to detect a second object, different from the target object, and the object volume prediction circuit is further configured to detect whether the target object is a neighbor of the second object without a third object therebetween.

In some embodiments, the object volume prediction circuit is further configured to determine whether the third object occludes a portion of the target object.

In some embodiments, the object volume prediction circuit is further configured to adjust the predicted volume of the target object based on whether the target object is occluded by the third object.

In some embodiments, the object volume prediction circuit is further configured to: determine a predicted 2D bounding box for the target object based on the 2D image data; determine neighbor relationship data based on a relative location of a plurality of objects in the 2D image data with respect to the target object; and determine the predicted volume occupied by the target object within the 3D point data based on the predicted 2D bounding box and the neighbor relationship data.

According to some embodiments of the present disclosure, a computer program product for operating an electronic device comprising a non-transitory computer readable storage medium having computer readable program code embodied in the medium that when executed by a processor causes the processor to perform the operations comprising: receiving three-dimensional (3D) point data and two-dimensional (2D) image data representing a field of view including a target object; and determining a predicted volume occupied by the target object within the 3D point data based on the 3D point data and the 2D image data.

In some embodiments, the operations further comprise analyzing the 2D image data utilizing a plurality of neural network models, wherein the plurality of neural network models are configured to generate respective 2D bounding boxes for the target object based on the 2D image data.

In some embodiments, the plurality of neural network models are further configured to generate respective object classifications for the target object based on the 2D image data.

In some embodiments, the operations further comprise generating a final bounding box based on the respective 2D bounding boxes of the plurality of neural network models.

In some embodiments, the operations further comprise generating the final bounding box based on an overlapping area between two or more of the respective 2D bounding boxes of the plurality of neural network models.

In some embodiments, the operations further comprise generating the final bounding box based on a deviation of the two or more of the respective 2D bounding boxes of the plurality of neural network models from the overlapping area.

In some embodiments, the neural network models comprise respective model bias scores, and the operations further comprise generating the final bounding box based on the respective model bias scores of the plurality of neural network models.

In some embodiments, the operations further comprise: analyzing the 2D image data to detect a second object, different from the target object, and detecting whether the target object is a neighbor of the second object without a third object therebetween.

In some embodiments, the operations further comprise determining whether the third object occludes a portion of the target object.

In some embodiments, the operations further comprise adjusting the predicted volume of the target object based on whether the target object is occluded by the third object.

In some embodiments, the operations further comprise: determining a predicted 2D bounding box for the target object based on the 2D image data; determining neighbor relationship data based on a relative location of a plurality of objects in the 2D image data with respect to the target object; and determining the predicted volume occupied by the target object within the 3D point data based on the predicted 2D bounding box and the neighbor relationship data.

According to some embodiments of the present disclosure, a method of operating a Light Detection and Ranging (lidar) system comprising: receiving three-dimensional (3D) point data and two-dimensional (2D) image data representing a field of view including a target object; and determining a predicted volume occupied by the target object within the 3D point data based on the 3D point data and the 2D image data.

In some embodiments, the method further includes analyzing the 2D image data utilizing a plurality of neural network models, wherein the plurality of neural network models are configured to generate respective 2D bounding boxes for the target object based on the 2D image data.

In some embodiments the plurality of neural network models are further configured to generate respective object classifications for the target object based on the 2D image data.

In some embodiments, the method further includes generating a final bounding box based on the respective 2D bounding boxes of the plurality of neural network models.

In some embodiments, the method further includes generating the final bounding box based on an overlapping area between two or more of the respective 2D bounding boxes of the plurality of neural network models.

In some embodiments, the method further includes generating the final bounding box based on a deviation of the two or more of the respective 2D bounding boxes of the plurality of neural network models from the overlapping area.

In some embodiments, the neural network models comprise respective model bias scores, and the method further includes generating the final bounding box based on the respective model bias scores of the plurality of neural network models.

In some embodiments, the method further includes analyzing the 2D image data to detect a second object, different from the target object, and detecting whether the target object is a neighbor of the second object without a third object therebetween.

In some embodiments, the method further includes determining whether the third object occludes a portion of the target object.

In some embodiments, the method further includes adjusting the predicted volume of the target object based on whether the target object is occluded by the third object.

In some embodiments, the method further includes: determining a predicted 2D bounding box for the target object based on the 2D image data; determining neighbor relationship data based on a relative location of a plurality of objects in the 2D image data with respect to the target object; and determining the predicted volume occupied by the target object within the 3D point data based on the predicted 2D bounding box and the neighbor relationship data.

Other devices, apparatus, and/or methods according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF DRAWINGS

FIG. 1 is a schematic view of an example of a lidar system or circuit in accordance with embodiments of the present disclosure.

FIG. 2 is a schematic view of an example of a control circuit in accordance with embodiments of the present disclosure.

FIG. 3 illustrates a schematic view of a process for automatically annotating point cloud data in accordance with embodiments of the present disclosure.

FIG. 4 illustrates a schematic view of a multi-model based inference module/circuit in accordance with embodiments of the present disclosure.

FIG. 5 illustrates a schematic view of a multi-factor cross-validation module/circuit in accordance with embodiments of the present disclosure.

FIGS. 6A to 6C illustrate examples of the prediction of the 2D bounding boxes in accordance with some embodiments of the present disclosure.

FIG. 7 illustrates a schematic view of an object neighbor relationships determination module/circuit in accordance with embodiments of the present disclosure.

FIG. 8 is a schematic illustration of neighboring object relationships in accordance with some embodiments of the present disclosure.

FIG. 9 illustrates a schematic view of a point cloud clustering module/circuit in accordance with embodiments of the present disclosure.

FIG. 10 is a schematic illustration of a 2D-3D integration module/circuit in accordance with some embodiments of the present disclosure.

FIG. 11 is a schematic illustration of a volume estimation module/circuit in accordance with some embodiments of the present disclosure.

FIG. 12 is a schematic illustration of an occlusion awareness module/circuit in accordance with some embodiments of the present disclosure.

FIG. 13 is a schematic illustration of an object level volume prediction module/circuit in accordance with some embodiments of the present disclosure.

### DETAILED DESCRIPTION

A lidar system may include an array of emitters and an array of detectors, or a system having a single emitter and an array of detectors, or a system having an array of emitters and a single detector. As described herein, one or more emitters may define an emitter unit, and one or more detectors may define a detector pixel. A flash lidar system may acquire images by emitting light from an array of emitters, or a subset of the array, for short durations (pulses) over a field of view (FoV) or scene, and detecting the echo signals reflected from one or more targets in the FoV at one or more detectors. A non-flash or scanning lidar system may generate image frames by raster scanning light emission (continuously) over a field of view or scene, for example, using a point scan or line scan to emit the necessary power per point and sequentially scan to reconstruct the full FoV.

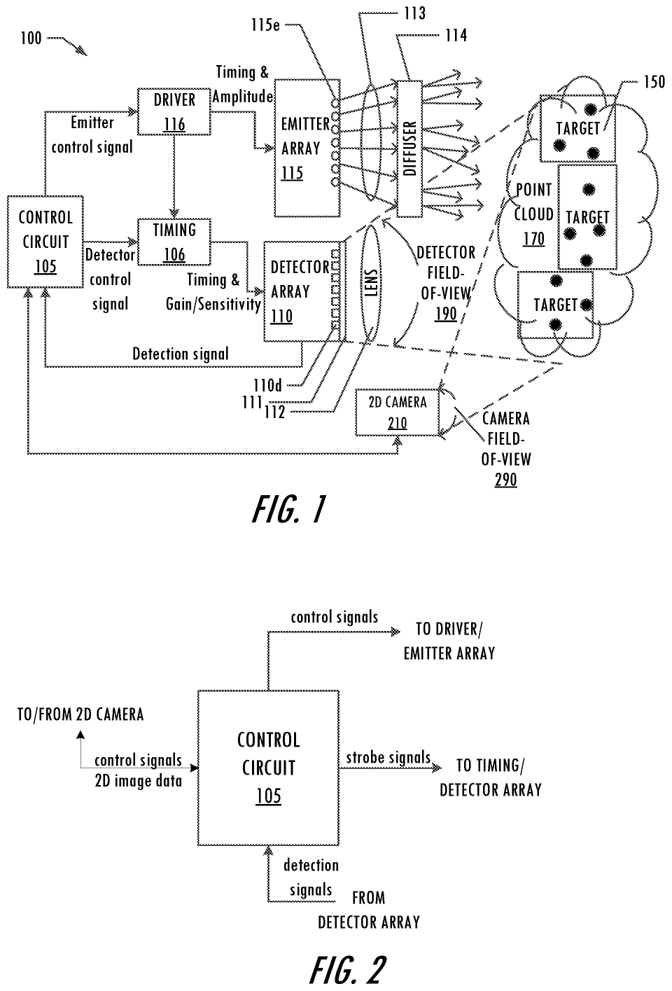

An example of a lidar system or circuit 100 in accordance with embodiments of the present disclosure is shown in FIG. 1. The lidar system 100 includes a control circuit 105, a timing circuit 106, an emitter array 115 including a plurality of emitters 115e, and a detector array 110 including a plurality of detectors 110d. The detectors 110d include time-of-flight sensors (for example, an array of single-photon detectors, such as SPADs). One or more of the emitter elements 115e of the emitter array 115 may define emitter units that respectively emit a radiation pulse or continuous wave signal (for example, through a diffuser or optical filter 114) at a time and frequency controlled by a timing generator or driver circuit 116. In particular embodiments, the emitters 115e may be pulsed light sources, such as LEDs or lasers (such as vertical cavity surface emitting lasers (VCSELs)). Radiation is reflected back from a target 150, and is sensed by detector pixels defined by one or more detector elements 110d of the detector array 110. The control circuit 105 implements a pixel processor that measures and/or calculates the time of flight of the illumination pulse over the journey from emitter array 115 to target 150 and back to the detectors 110d of the detector array 110, using direct or indirect ToF measurement techniques.

In some embodiments, an emitter module or circuit 115 may include an array of emitter elements 115e (e.g., VCSELs), a corresponding array of optical elements 113,114 coupled to one or more of the emitter elements (e.g., lens(es) 113 (such as microlenses) and/or diffusers 114), and/or driver circuitry 116. The optical elements 113, 114 may be optional, and can be configured to provide a sufficiently low beam divergence of the light output from the emitter elements 115e so as to ensure that fields of illumination of either individual or groups of emitter elements 115e do not significantly overlap, and yet provide a sufficiently large beam divergence of the light output from the emitter elements 115e to provide eye safety to observers.

The driver circuitry 116 may each correspond to one or more emitter elements, and may each be operated responsive to timing control signals with reference to a master clock and/or power control signals that control the peak power of the light output by the emitter elements 115e. In some embodiments, each of the emitter elements 115e in the emitter array 115 is connected to and controlled by a respective driver circuit 116. In other embodiments, respective groups of emitter elements 115e in the emitter array 115 (e.g., emitter elements 115e in spatial proximity to each other), may be connected to a same driver circuit 116. The driver circuit or circuitry 116 may include one or more driver transistors configured to control the modulation frequency, timing and amplitude of the optical emission signals that are output from the emitters 115e.

The emission of optical signals from multiple emitters 115e provides a single image frame for the flash LIDAR system 100. The maximum optical power output of the emitters 115e may be selected to generate a signal-to-noise ratio of the echo signal from the farthest, least reflective target at the brightest background illumination conditions that can be detected in accordance with embodiments described herein. An optional filter to control the emitted wavelengths of light and diffuser 114 to increase a field of illumination of the emitter array 115 are illustrated by way of example.

Light emission output from one or more of the emitters 115e impinges on and is reflected by one or more targets 150, and the reflected light is detected as an optical signal (also referred to herein as a return signal, echo signal, or echo) by one or more of the detectors 110d (e.g., via receiver optics 112), converted into an electrical signal representation (referred to herein as a detection signal), and processed (e.g., based on time of flight) to define a 3-D point cloud representation 170 of the field of view 190. Operations of lidar systems in accordance with embodiments of the present disclosure as described herein may be performed by one or more processors or controllers, such as the control circuit 105 of FIG. 1.

In some embodiments, a receiver/detector module or circuit 110 includes an array of detector pixels (with each detector pixel including one or more detectors 110d, e.g., SPADs), receiver optics 112 (e.g., one or more lenses to collect light over the FoV 190), and receiver electronics (including timing circuit 106) that are configured to power, enable, and disable all or parts of the detector array 110 and to provide timing signals thereto. The detector pixels can be activated or deactivated with at least nanosecond precision, and may be individually addressable, addressable by group, and/or globally addressable. The receiver optics 112 may include a macro lens that is configured to collect light from the largest FoV that can be imaged by the lidar system, microlenses to improve the collection efficiency of the detecting pixels, and/or anti-reflective coating to reduce or prevent detection of stray light. In some embodiments, a spectral filter 111 may be provided to pass or allow passage of ‘signal’ light (i.e., light of wavelengths corresponding to those of the optical signals output from the emitters) but substantially reject or prevent passage of non-signal light (i.e., light of wavelengths different than the optical signals output from the emitters).

The detectors 110d of the detector array 110 are connected to the timing circuit 106. The timing circuit 106 may be phase-locked to the driver circuitry 116 of the emitter array 115. The example, when the detector elements include reverse-biased photodiodes, avalanche photodiodes (APD), PIN diodes, and/or Geiger-mode Avalanche Diodes (SPADs), the reverse bias may be adjusted, whereby, the higher the overbias, the higher the sensitivity.

In some embodiments, a control circuit 105, such as a microcontroller or microprocessor, provides different emitter control signals to the driver circuitry 116 of different emitters 115e and/or provides different signals (e.g., strobe signals) to the timing circuitry 106 of different detectors 110d to enable/disable the different detectors 110d so as to detect the echo signal from the target 150.

In some embodiments, the control circuit 105 may be further coupled to a two-dimensional (2D) camera 210, such as an RGB camera. The 2D camera 210 may include, for example, a charge-coupled device (CCD) camera or a complementary metal oxide semiconductor (CMOS) camera, but the embodiments described herein are not limited thereto. The 2D camera 210 may have a field of view 290 that at least partially overlaps with the field of view 190 for the detector array 110. Thus, the 2D camera 210 and the detector array 110 may be capable of receiving signals from a same view and/or scene. The detector array 110 may generate detection signals including 3D point data defining a 3D point cloud 170 representation of the field of view 190, and the 2D camera 210 may also generate detection signals including 2D image data of the field of view 190. The control circuit 105 may be configured to control the 2D camera 210 (e.g., activate and/or change operating characteristics thereof) and may be configured to receive data (e.g., 2D image data) from the 2D camera 210.

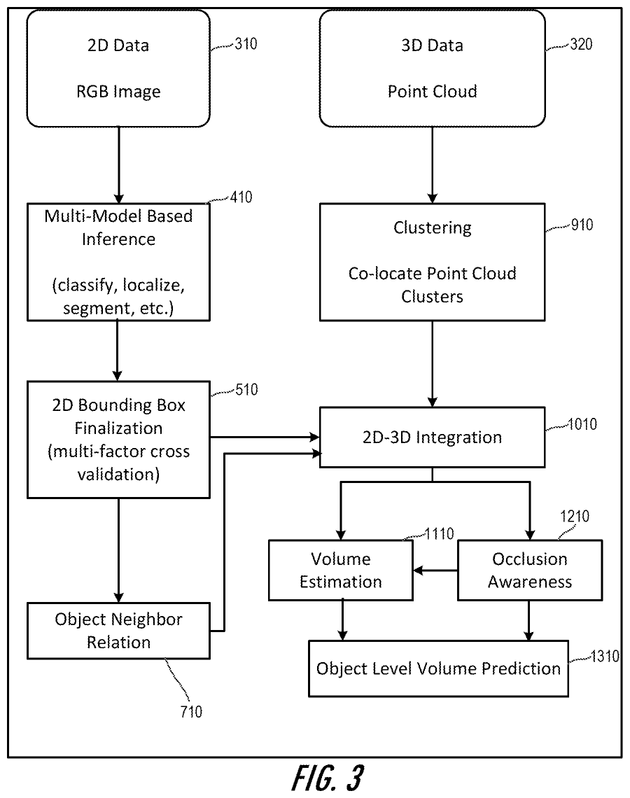

An example of a control circuit 105 that generates emitter and/or detector control signals is shown in FIG. 2. The control circuit of FIG. 2 may represent one or more control circuits, for example, an emitter control circuit that is configured to provide the emitter control signals to the driver circuitry 116 of the emitter array 115 and/or a detector control circuit that is configured to provide the strobe signals to the timing circuitry 106 of the detector array 110 as described herein and/or a 2D camera control circuit that is configured to control the 2D camera 210 as described herein. Also, the control circuit 105 may include a sequencer circuit that is configured to coordinate operation of the emitters 115e and detectors 110d. More generally, the control circuit 105 may include one or more circuits that are configured to generate the respective detector signals that control the timing and/or durations of activation of the detectors 110d, and/or to generate respective emitter control signals that control the output of optical signals from the emitters 115e. The control circuit 105 may also include one or more circuits that are configured to control the timing and/or operation of the 2D camera 210, and/or to receive imaging data from the 2D camera 210.

Embodiments described herein include methods and systems for automated point-cloud dataset labelling using a fusion of data from 2D imaging (e.g., RGB data; generally referred to as 2D image data) and data from 3D imaging (e.g., point cloud and depth information; generally referred to as 3D point data) from a lidar system. The embodiments described herein may use multiple 2D perception models to localize and identify objects in the scene represented by 2D image data. This information may then be used to co-locate a 2D plane (based on the 2D image data) in the 3D point cloud and extract 3D clusters for association with the objects in the scene.

Artificial Intelligence (AI) and/or Machine/Deep learning algorithms may utilize annotated datasets for creating effective models. Annotated data means that a given dataset may have one or more pieces of metadata associated with (e.g., annotated to) individual elements of the dataset. For example, with respect to image data, a cluster of points in a 3D point cloud may be labeled/annotated to indicate that the cluster of points represents a particular object in 3D space. For example, the cluster of points may be annotated as being associated with and/or representing an automobile. In embodiments described herein, an annotated dataset may be created from point-cloud data, depth-map data, and/or intensity data from a lidar system. The process of annotating a dataset is normally man hour intensive and time consuming. Thousands of pieces of data may need to be viewed by a person if done manually, with respective decisions and input being made multiple times per dataset. For large datasets, especially in image processing arenas, such a time-intensive process may be practically infeasible to be done by a person. Embodiments described herein provide methods and system that can automate this annotation process. Embodiments described herein may result in more accurate and deterministic result, thus resulting in a technological improvement to lidar systems.

For 3D point cloud data, the problem of data annotation has not been sufficiently addressed. Particularly data annotation as applied the richness of the point cloud data (high resolution, high frame-rate global shutter) that may be generated by a lidar system has not been available in the existing AI datasets. Thus, embodiments described herein provide a technological improvement to lidar systems that does not currently exist.

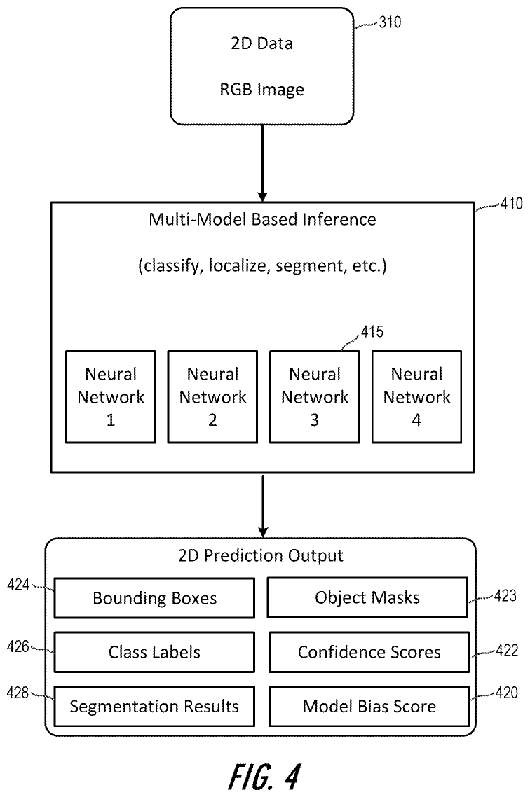

FIG. 3 illustrates a schematic view of a process for automatically annotating point cloud data according to some embodiments described herein. FIG. 3 illustrates modules of systems and/or processes configured to provide automated generation of a point-cloud dataset according to embodiments of the present disclosure along with the associated data flow. The operations of FIG. 3 may be performed, for example, by the control circuit 105 of FIG. 1, but the present inventive concepts are not limited thereto.

As illustrated in FIG. 3, systems and methods associated with the present disclosure may include both 2D data 310, which may be in the form of an RGB image (e.g., from camera 210) for example, and 3D data 320, which may be in the form of a point cloud (e.g., point cloud 170 identified by detector array 110).

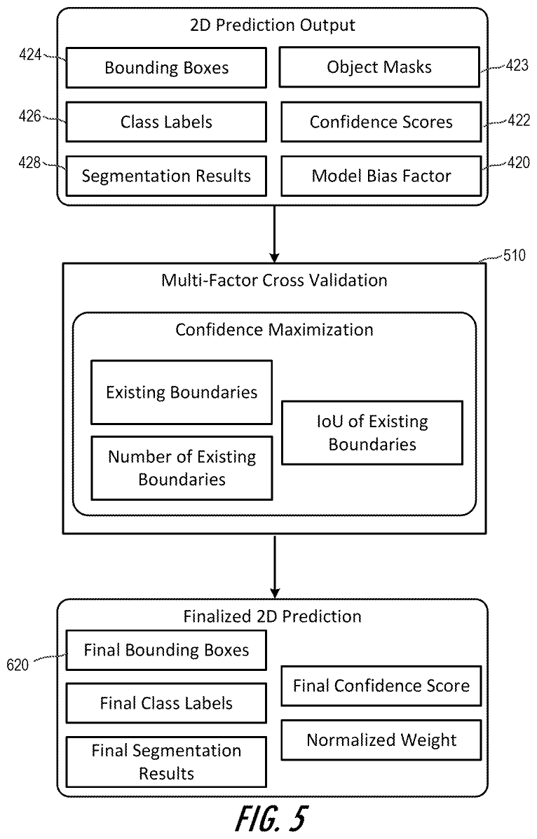

The 2D data 310 may first be processed by a module and/or circuit 410 that performs multi-model based inference. FIG. 4 illustrates a schematic view of a multi-model based inference module/circuit 410 in accordance with embodiments of the present disclosure. An objective of the multi-model based inference circuit 410 may be to detect and localize objects of interest in the 2D data 310 (e.g., a camera image). Referring to FIG. 4, the 2D data 310 may be processed by a plurality of neural networks 415. Respective ones of the neural networks 415 may be computer systems comprising one or more inputs and one or more outputs connected by a plurality of hidden layers. The neural networks 415 may be configured to detect objects within a 2D image 310 based on prior training of the neural network 415 with particular datasets of images. Respective ones of the neural networks 415 may execute on one or more processors of a computer system.

Though FIG. 4 illustrates four neural networks 415, it will be understood that this is merely an example, and that a different number of neural networks 415 may be used without deviating from the scope of the present disclosure. As any image detector neural network 415 may not be perfectly accurate, using just a single network can lead to missing objects even if present or a misclassification of the object. To avoid this problem, embodiments described herein utilize the plurality of different neural network architectures 415 trained on different datasets to improve the recall and precision. If an object is missed and/or misclassified by one neural network 415, there is still a probability that other neural networks 415 will detect the object correctly. In addition, the use of a plurality of different neural network architectures 415 may eliminate and/or reduce false positive detections by any individual one of the neural networks 415.

The multi-model based inference module/circuit module 410 may receive the 2D data 310 (e.g., the camera image) and run multiple detection neural networks 415 in parallel. Detections made by the neural networks 415 are arranged in categories of bounding box coordinates, object class, and detection score. The data associated with the detections may be passed to a verification step. Respective ones of the multiple detection neural networks 415 may differ from one another in one or more ways. For example, respective ones of the multiple neural networks 415 may be trained on different datasets, be based on a different underlying architecture, and/or other differences.

A model bias score 420 may be used for each one of the model predictions from the neural networks 415. The model bias score 420 may depend on the benchmarking of the corresponding neural network 415. For example, the model bias score 420 may be used to weight the results of a particular neural network model 415 relative to other ones of the neural network models 415. The model bias score 420 may indicate a particular preference for a given neural network 415 related to particular types of datasets.

The predictions from respective ones of the neural network models 415 may be passed through a classification neural network to verify the predictions from each of the neural network modules 415. As illustrated in FIG. 4 outputs of the multi-model based inference module/circuit 410 may include one or more bounding boxes 424, object masks 423, class labels 426, segmentations results 428, and/or confidences scores 422.

The bounding boxes 424 output from the multi-model based inference module/circuit 410 may include virtual boxes and/or boundaries that enclose portions of the 2D data 310 that are tentatively identified as including one or more objects of interest. The class labels 426 may include estimations of the type of the object(s) within the bounding box 424 (e.g., person, automobile, tree, etc.). The confidence score 422 may be a number (e.g., generated by the neural network architecture 415) indicating a probability/confidence in the generated bounding box 424. For example, a higher confidence score 422 may indicate a higher likelihood that the object bounding box 424 and/or classification 426 is correct.

Referring back to FIG. 3, the output of the multi-model based inference module/circuit 410 may be passed to a module/circuit 510 configured to perform 2D bounding box finalization and multi-factor cross-validation. FIG. 5 illustrates a schematic view of a multi-factor cross-validation module/circuit 510 in accordance with embodiments of the present disclosure. The multi-factor cross-validation module/circuit 510 may filter out object detections with high probabilities from the detections of the plurality of neural network models 415 from multi-model based inference module/circuit 410. The multi-factor cross-validation module/circuit 510 may receive as input the predictions from multiples ones of the 2D object detection neural networks 415 in the multi-model based inference module/circuit 410 (e.g., the bounding boxes 424, class labels 426, segmentation results 428, confidence scores 422, and model bias scores 420).

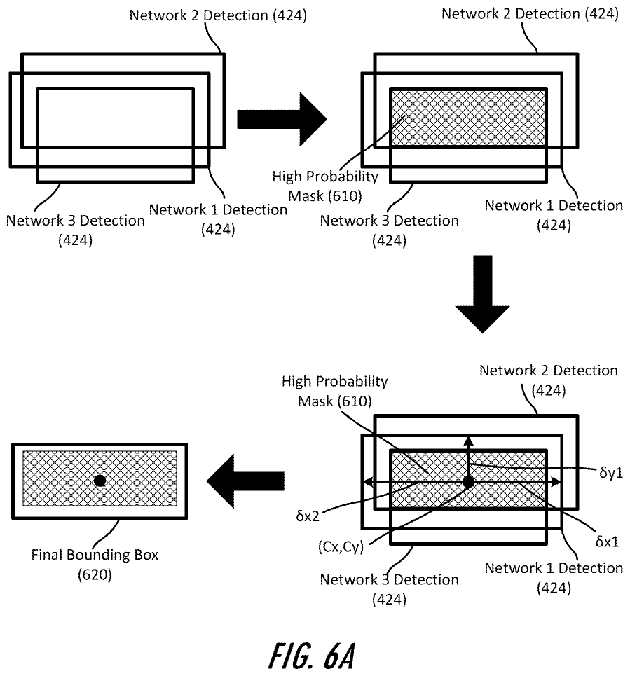

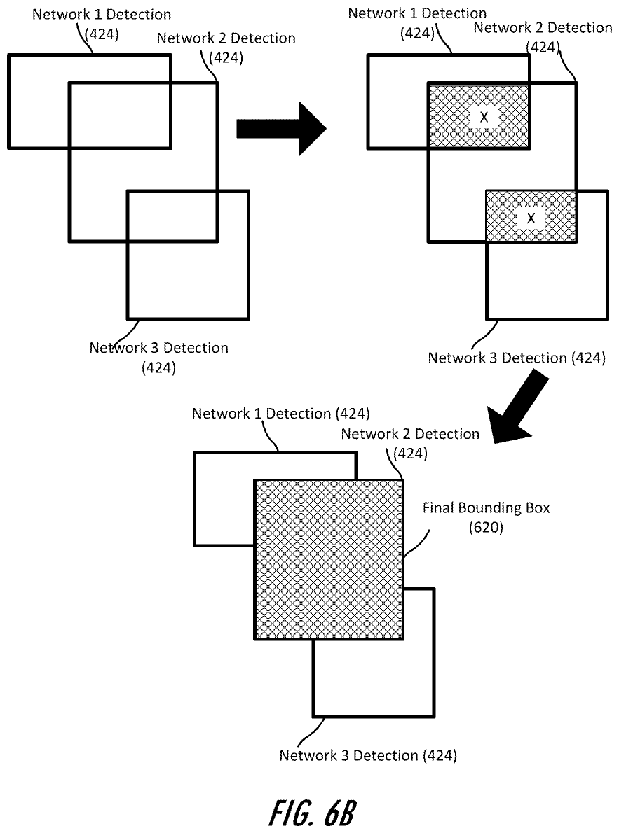

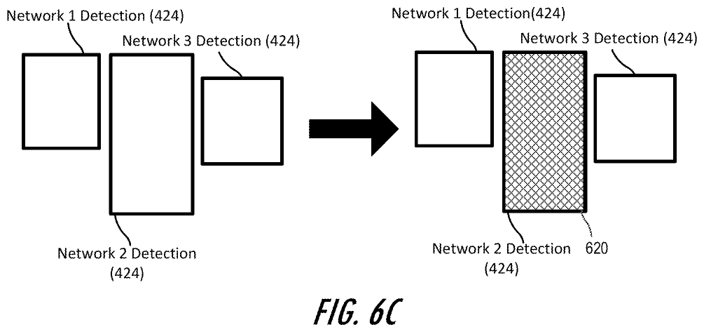

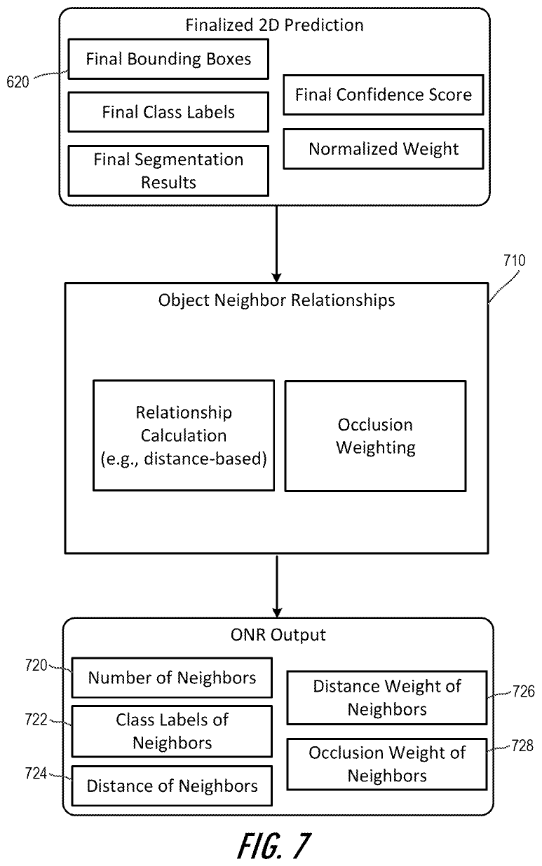

FIGS. 6A to 6C illustrate examples of the prediction of the 2D bounding boxes 424 in accordance with some embodiments of the present disclosure. In FIG. 6A, a scenario in which each of the predicted bounding boxes 424 overlaps is illustrated.

Referring to FIG. 6A, the multi-factor cross-validation module/circuit 510 may first determine, from among the results from the plurality of neural network models 415, the bounding box predictions 424 which overlap for the same class predictions. For each interested object label, a heatmap may be created. As used herein, a heatmap is a mask where each pixel in the heatmap will indicate the weighted prediction score for a given class label 426. If an object's heatmap average scores fall below a predetermined threshold, it will be considered as false positive and will be discarded.

Given multiple predictions, the maximum probability overlapping area for each of the predictions (e.g., bounding box 424) for each class label 426 may be found, which may be classified as a high probability mask 610. Next, a predicted center (Cx, Cy) for the object may be determined based on the center of the high probability mask 610. The final bounding box 620 coordinates for the object may then be calculated by using weighted score averaging of deviations of the predictions from the center (Cx, Cy) of the object in four directions.

For example, referring to FIG. 6A, a center point (Cx, Cy) of the high probability mask 610 may be determined. The deviations from the center point (Cx, Cy) may be determined. Example deviations for one of the network detection are illustrated in FIG. 6A as δx1, δx2, and δy1.

The coordinates of a final bounding box 620 may be determined based on the high probability mask 610. For example, the boundary of the final bounding box 620 may be given by:

$${δ}_{p}^{′} = \frac{{Σ}_{i = 1}^{m} {w}_{i} ( {δ}_{p} )}{m}$$

$$P = P + {δ}_{p}^{′}$$

where wᵢ is the normalized weight assigned to a given neural network 415, δₚ is the difference between a predicted boundary (e.g., bounding box 424) of an object and the center of the bounding box 424 (e.g., the high probability mask 610), m is the number of neural networks 415 used for the prediction, and P is the existing boundary of the bounding box 424.

FIG. 6B illustrates a scenario in which not all of the predictions are overlapping equal to an image over union (IoU) threshold, but there is an object present which is detected correctly by at least one neural network 415. An image over union for overlapping bounding boxes 424 may include all of the area enclosed within each bounding box 424 in addition to any overlapping areas. Here a maximum overlapping area between the various models and the model bias score 420 may be used to filter out the bounding box predictions 424 from the various neural networks 415.

Referring to FIG. 6B, for every bounding box prediction 424, the overlapping area with every other bounding box predictions 424 may be calculated (as shown marked with an ‘X’ in the prediction from Network 2). If the overlapping area is below a predetermined threshold, it may be discarded. The bounding box prediction 424 with the maximum sum of overlapping area (e.g., with respect to the other bounding boxes 424) may be selected as the prediction for the final bounding box 620. In some embodiments, the model bias score 420 of the neural network model 415 used to generate the bounding box prediction 424 may also be used in selecting (e.g., as a weighting factor) the final prediction 620. In FIG. 6B, the selected bounding box prediction 620 is that of Network 2. Thus, the final bounding box may be given by:

Final Bounding box=max(overlap area+model bias score)

FIG. 6C illustrates a scenario in which none of the bounding box predictions 424 are overlapping. In such a scenario, it may be possible that an object is not present and all the predictions 424 are false, but it may also be possible that an object is present and at least one bounding box prediction 424 is right. In this case, a final bounding box 620 will be chosen that was generated by the neural network model 415 with the maximum model bias score 420 that passes a predetermined threshold. Thus, the final bounding box 620 may be given by:

Final Bounding box=max(model bias score)

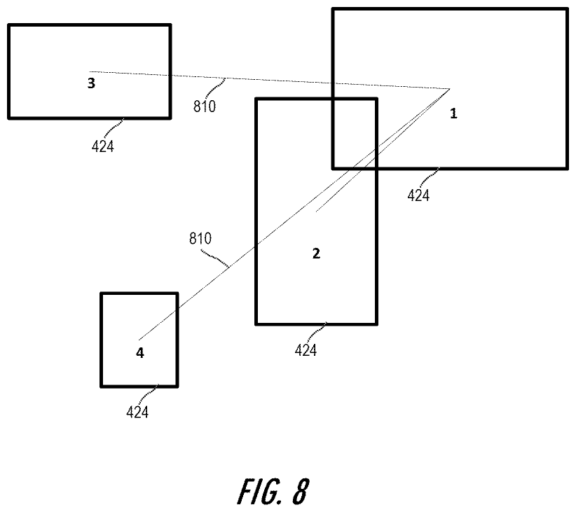

Referring back to FIG. 3, the output of the 2D bounding box finalization 510 may be passed to a module/circuit 710 configured to determine object neighbor relations. FIG. 7 illustrates a schematic view of an object neighbor relationships determination module/circuit 710 in accordance with embodiments of the present disclosure.

The objective of determining object neighbor relationships may include defining the relations between the bounding box predictions 424. The task of the object neighbor relationships determination module/circuit 710 may include defining the relations of all bounding box predictions 424, identifying non-occluded predictions, identifying occluded predictions and their neighbors, along with an occlusion percentage for the occluded predictions, and, if a prediction is occluded, determining whether the center of the prediction lies in the overlap region. As used herein, an occluded prediction may be a predicted bounding box 424 in which at least a portion of the bounding box 424 is covered/occluded (e.g., by another bounding box 424). This may mean that the camera's view of the object was blocked/occluded by another object.

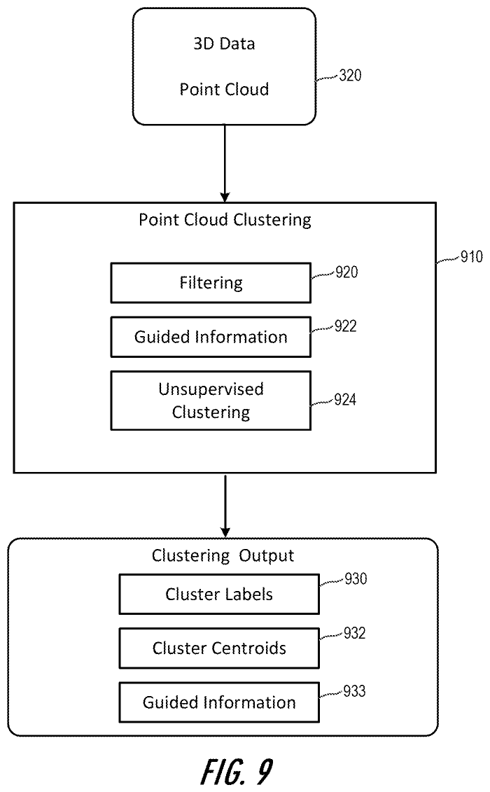

FIG. 8 is a schematic illustration of neighboring object relationships in accordance with some embodiments of the present disclosure. As illustrated in FIG. 8, various ones of the bounding boxes 424 from a particular corresponding FOV may be combined together into a single view. The neighbor relations for a given bounding box 424 may be defined by connecting a straight-line 810 from a center of the bounding box 424 with every other box center. If the line 810 connecting two bounding boxes 424, where the line 810 is oriented based on the lidar/camera position and the field of view, passes through any other bounding box 424, the bounding box 424 will be considered occluded, and will not be considered. For example, in FIG. 8, Box 1 would be considered as occluded (e.g., by Box 2) with respect to Box 4, and Box 4 would not be considered for purposes of determining a neighbor to Box 1. A first bounding box 424 with a center line 810 to a second bounding box 424 that does not pass through any other box 424 will be considered as direct neighbor (e.g., not occluded) for the second bounding box 424. For example, in FIG. 8, Boxes 2 and 3 would be considered neighbors to Box 1.

The outputs of the object neighbor relationships determination module/circuit 710 may include, for each of the bounding boxes 424, a number of neighbors 720, class labels of the neighbors 722, distances of the neighbors 724, a distance weight of the neighbors 726, and an occlusion weight of the neighbors 728. In some embodiments, the neighbors may be assigned for each object with equal occlusion weight 728, and, in some embodiments, the occlusion weight (OW) 728 may be decided by the overlap area of the bounding boxes 424. For example, the occlusion weight OW 728 may be determined by:

OW=(Area of bounding box overlap)/(Area of bounding box for the respective object)

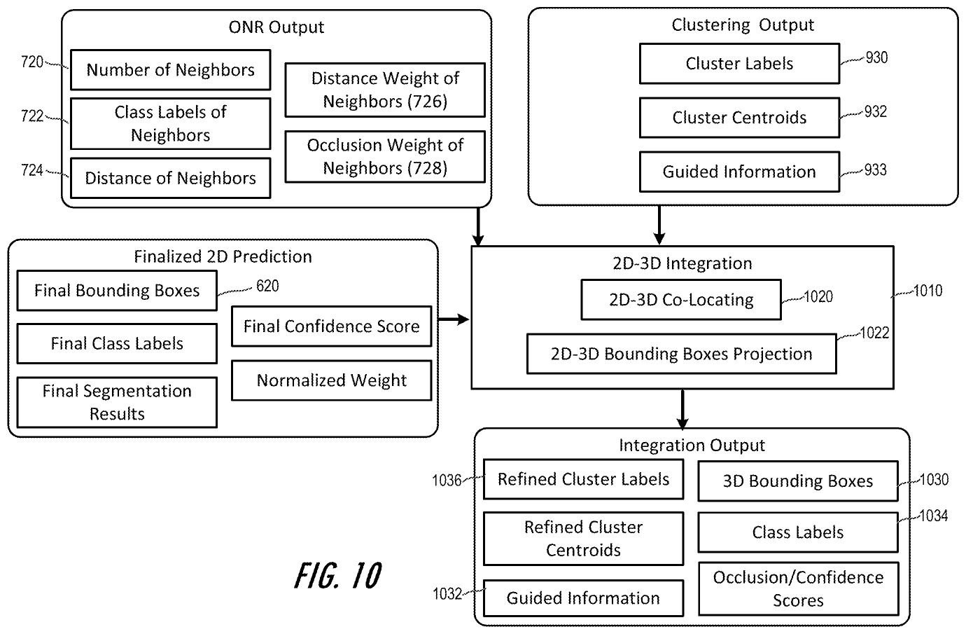

Referring back to FIG. 3, the 3D data 320 may also be processed. The 3D data 320 may first be processed by a point cloud clustering module/circuit 910. FIG. 9 illustrates a schematic view of a point cloud clustering module/circuit 910 in accordance with embodiments of the present disclosure. The point cloud clustering module/circuit 910 may process large amounts of 3D points and extract clusters (e.g., groupings of detecting points) related to the objects in the scene. The point cloud clustering module/circuit 910 can serve as the first step of multiple applications of perceiving the scene based on point cloud data 320, such as object classification, detection, localization, and/or volume estimation.

One of the challenges of clustering large amounts of 3D points in a point cloud 320 is handling multiple types of noise according to different scenes and performing efficient clustering. Some embodiments described herein may address the problems by incorporating multiple filters and guided information to reduce the time complexity and improve the performance of clustering algorithms. The filters 920 may include statistical types and guided information-based types. Guided information 922 includes surface normal vector, mesh, edge, neighbor relation, etc. These filters 920 may be used for clustering point clouds with most unsupervised clustering algorithms 924, such as k-means, DBSCAN, Gustafson-Kessel (GK) clustering, etc. Outputs of the point cloud clustering module circuit 910 may include cluster labels 930, cluster centroids 932 (e.g., within the point cloud), and guided information 934. In some embodiments, guided information 934 can be based on or include a surface normal vector, a mesh, an edge, a neighbor relation, etc.

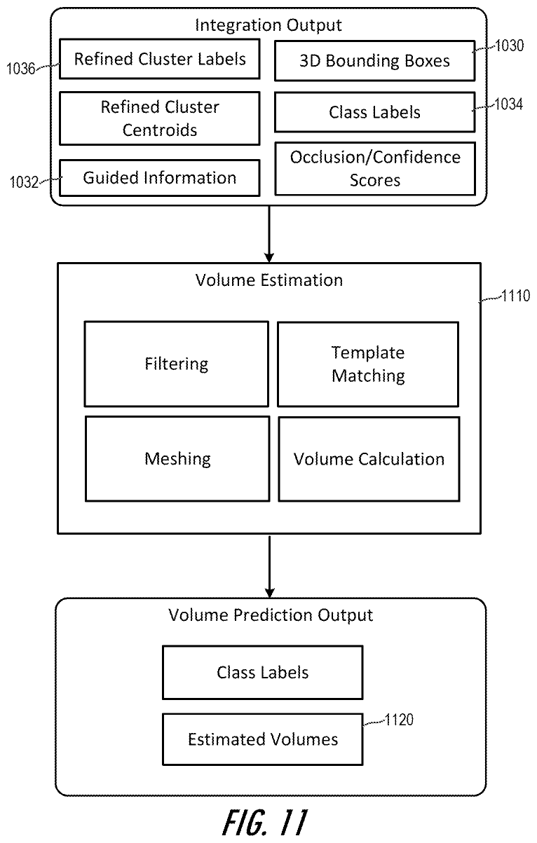

Referring back to FIG. 3, the output of the 3D clustering 910, along with the output of the 2D bounding box finalization 510 and the 2D object neighbor relation determination 710 may be passed to a 2D-3D integration module/circuit 1010. FIG. 10 is a schematic illustration of a 2D-3D integration module/circuit 1010 in accordance with some embodiments of the present disclosure.

The 2D-3D integration module/circuit 1010 may take the outputs from 2D prediction and 3D clustering with object neighbor relations and guided information from point clouds, and may create 2D-3D co-located bounding boxes 1030, class labels 1034, guided information 1032, and/or cluster labels 1036 for objects in the scene. The 2D-3D integration module circuit according to some embodiments of the present disclosure may include at least two functions. The first function may include co-locating objects 1020 (e.g., in the point cloud) based on 2D bounding boxes 620 and/or 3D cluster centroids 932. The second function is creating 1022 projected 3D bounding boxes 1030 using information from 2D bounding boxes, 3D clusters, and/or camera calibration parameters. The shape of the projected 3D bounding boxes 1030 can be a frustum, cylinder, etc. The projected 3D bounding boxes 1030 may identify a 3D area projected to enclose an object detected within the point cloud 320.

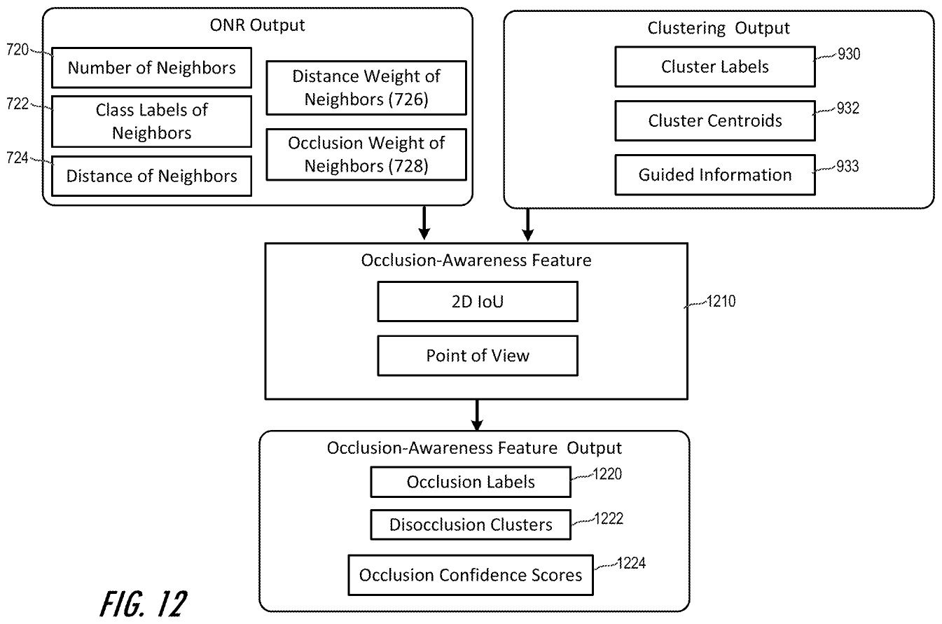

Referring back to FIG. 3, the output of the 2D-3D integration module/circuit 1010 may be passed to a volume estimation module/circuit 1110. FIG. 11 is a schematic illustration of a volume estimation module/circuit 1110 in accordance with some embodiments of the present disclosure.

Referring to FIG. 11, the volume estimation module/circuit 1110 may estimate the volume 1120 of each object in the scene based on 3D point cloud data 320. The challenges addressed by this module/circuit include the visibility of perceived objects, as well as the implementation of fast and accurate processing algorithms. It is not always possible to obtain points on the surfaces that are not visible directly from the measuring position (e.g., from the 2D camera and/or 3D detector). This may mean that to cover the complete objects, guided information 1032 may be used to help with estimating the accurate surface of objects.

One step is to distinguish and remove outliers and maximally reduce noise and size of the data set. Then meshing on the surface of the point clouds may be performed using guided information 1032 such as normal vectors and edges to create shape features and geometric information. Meshing may include the generation of the 3D representation made of a series of interconnected shapes (e.g., a “mesh”) that outline a surface of the 3D object. The mesh can polygonal or triangular, though the present disclosure is not limited thereto. Furthermore, the template matching for each object class may be used to predict correct bounding box predictions. Voxel templates may be created for each class depending on their dimensions and shape features.

After the volume estimation first phase, the volume shape may be compared to a set of predefined shape templates to estimate the confidence of the resulting point cloud cluster being an accurate representation on the object in the scene. The final step is to calculate the object volume 1120 based on the refined boundary of the object in the scene.

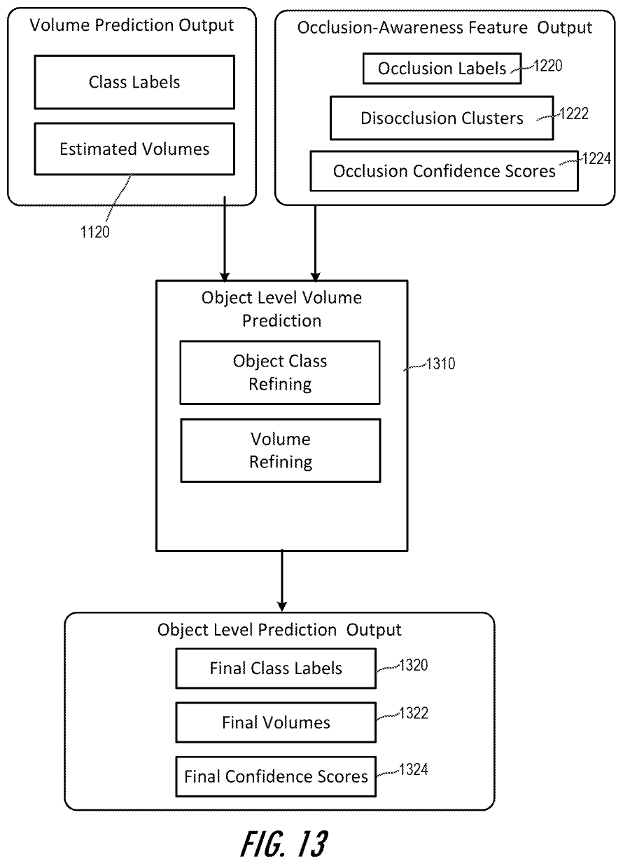

Referring back to FIG. 3, the output of the 2D-3D integration module/circuit 1010 may also be passed to an occlusion awareness module/circuit 1210. FIG. 12 is a schematic illustration of an occlusion awareness module/circuit 1210 in accordance with some embodiments of the present disclosure.

The occlusion awareness module/circuit 1210 may create occlusion awareness features (e.g., occlusion labels 1220, disocclusion clusters 1222, and/or occlusion confidence scores 1224) to further guide volume estimation when occlusion exists with different points of view based on neighbor locations. The goal of the occlusion awareness module/circuit 1210 may be to estimate the impact on missing points and misplaced points on point cloud clusters related to the objects in the scene. The output of the occlusion awareness module/circuit 1210 may also be used by the volume estimation module/circuit 1110 in its volume estimation calculations.

Referring back to FIG. 3, the output of the volume estimation module/circuit 1110 and the occlusion awareness module/circuit 1210 may be passed to an object level volume prediction module/circuit 1310. FIG. 13 is a schematic illustration of an object level volume prediction module/circuit 1310 in accordance with some embodiments of the present disclosure.

The object level volume prediction module/circuit 1310 may finalize volume estimation (e.g., of detected objects within the point cloud) by refining the direct volume estimation (e.g., from FIG. 11) with occlusion awareness features (e.g., from FIG. 12). In the object level volume prediction module/circuit 1310, misplaced points in occluded objects may be removed and a volume may be recalculated for those objects or otherwise calculated by excluding data corresponding to occluded objects or portions thereof. Outputs of the object level volume prediction module/circuit 1310 may include final class labels 1320 for the detected objects, final volumes 1322 for the detected objects, and/or final confidence scores 1324 for the detected objects. In some embodiments, the excluded data may be used to estimate the volume of another object.

Embodiments of the present disclosure benefit implementations using high resolution point cloud data in AI/Data Science based algorithms/applications. According to some embodiments described herein, image data from 2D cameras sharing portions of a field of view with a 3D ToF system can be used to more accurately detect, classify, and/or co-locate objects within a 3D point cloud.

Example embodiments of the present inventive concepts may be embodied in various devices, apparatuses, and/or methods. For example, example embodiments of the present inventive concepts may be embodied in hardware and/or in software (including firmware, resident software, micro-code, etc.). Furthermore, example embodiments of the present inventive concepts may take the form of a computer program product comprising a non-transitory computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Example embodiments of the present inventive concepts are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity.

The example embodiments are mainly described in terms of particular methods and devices provided in particular implementations. However, the methods and devices may operate effectively in other implementations. Phrases such as “example embodiment,” “one embodiment,” and “another embodiment” may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts.

The example embodiments will also be described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein.

It will be understood that when an element is referred to or illustrated as being “on,” “connected,” or “coupled” to another element, it can be directly on, connected, or coupled to the other element, or intervening elements may be present. In contrast, when an element is referred to as being “directly on,” “directly connected,” or “directly coupled” to another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise.

It will also be understood that the term “and/or” as used herein refers to and encompasses any and all possible combinations of one or more of the associated listed items. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entireties.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present invention described herein, and of the manner and process of making and using them, and shall support claims to any such combination or subcombination.

Although the invention has been described herein with reference to various embodiments, it will be appreciated that further variations and modifications may be made within the scope and spirit of the principles of the invention. Although specific terms are employed, they are used in a generic and descriptive sense only and not for purposes of limitation.

1. A Light Detection and Ranging (lidar) system, comprising:
a control circuit configured to receive three-dimensional (3D) point data and two-dimensional (2D) image data representing a field of view including a target object; and
an object volume prediction circuit configured to determine a predicted volume occupied by the target object within the 3D point data based on the 3D point data and the 2D image data.

2. The lidar system of claim 1, wherein the object volume prediction circuit is further configured to analyze the 2D image data utilizing a plurality of neural network models, wherein the plurality of neural network models are configured to generate respective 2D bounding boxes for the target object based on the 2D image data.

3. The lidar system of claim 2, wherein the plurality of neural network models are further configured to generate respective object classifications for the target object based on the 2D image data.

4. The lidar system of claim 2, wherein the object volume prediction circuit is further configured to generate a final bounding box based on the respective 2D bounding boxes of the plurality of neural network models.

5. The lidar system of claim 4, wherein the object volume prediction circuit is further configured to generate the final bounding box based on an overlapping area between two or more of the respective 2D bounding boxes of the plurality of neural network models.

6. The lidar system of claim 5, wherein the object volume prediction circuit is further configured to generate the final bounding box based on a deviation of the two or more of the respective 2D bounding boxes of the plurality of neural network models from the overlapping area.

7. The lidar system of claim 5, wherein the neural network models comprise respective model bias scores, and
wherein the object volume prediction circuit is further configured to generate the final bounding box based on the respective model bias scores of the plurality of neural network models.

8. The lidar system of claim 1, wherein the object volume prediction circuit is further configured to analyze the 2D image data to detect a second object, different from the target object, and
wherein the object volume prediction circuit is further configured to detect whether the target object is a neighbor of the second object without a third object therebetween.

9. The lidar system of claim 8, wherein the object volume prediction circuit is further configured to determine whether the third object occludes a portion of the target object.

10. The lidar system of claim 9, wherein the object volume prediction circuit is further configured to adjust the predicted volume of the target object based on whether the target object is occluded by the third object.

11. The lidar system of claim 1, wherein the object volume prediction circuit is further configured to:
determine a predicted 2D bounding box for the target object based on the 2D image data;
determine neighbor relationship data based on a relative location of a plurality of objects in the 2D image data with respect to the target object; and
determine the predicted volume occupied by the target object within the 3D point data based on the predicted 2D bounding box and the neighbor relationship data.

12. A computer program product for operating an electronic device comprising a non-transitory computer readable storage medium having computer readable program code embodied in the medium that when executed by a processor causes the processor to perform operations comprising:
receiving three-dimensional (3D) point data and two-dimensional (2D) image data representing a field of view including a target object; and
determining a predicted volume occupied by the target object within the 3D point data based on the 3D point data and the 2D image data.

13. The computer program product of claim 12, wherein the operations further comprise analyzing the 2D image data utilizing a plurality of neural network models, wherein the plurality of neural network models are configured to generate respective 2D bounding boxes for the target object based on the 2D image data.

14. The computer program product of claim 13, wherein the plurality of neural network models are further configured to generate respective object classifications for the target object based on the 2D image data.

15. The computer program product of claim 13, wherein the operations further comprise generating a final bounding box based on the respective 2D bounding boxes of the plurality of neural network models.

16. The computer program product of claim 15, wherein the operations further comprise generating the final bounding box based on an overlapping area between two or more of the respective 2D bounding boxes of the plurality of neural network models.

17. The computer program product of claim 16, wherein the operations further comprise generating the final bounding box based on a deviation of the two or more of the respective 2D bounding boxes of the plurality of neural network models from the overlapping area.

18. The computer program product of claim 16, wherein the neural network models comprise respective model bias scores, and
wherein the operations further comprise generating the final bounding box based on the respective model bias scores of the plurality of neural network models.

19. The computer program product of claim 12, wherein the operations further comprise:
analyzing the 2D image data to detect a second object, different from the target object, and
detecting whether the target object is a neighbor of the second object without a third object therebetween.

20. The computer program product of claim 19, wherein the operations further comprise determining whether the third object occludes a portion of the target object.

21. The computer program product of claim 20, wherein the operations further comprise adjusting the predicted volume of the target object based on whether the target object is occluded by the third object.

22. The computer program product of claim 12, wherein the operations further comprise:
determining a predicted 2D bounding box for the target object based on the 2D image data;
determining neighbor relationship data based on a relative location of a plurality of objects in the 2D image data with respect to the target object; and
determining the predicted volume occupied by the target object within the 3D point data based on the predicted 2D bounding box and the neighbor relationship data.

23. A method of operating a Light Detection and Ranging (lidar) system, the method comprising:
receiving three-dimensional (3D) point data and two-dimensional (2D) image data representing a field of view including a target object; and
determining a predicted volume occupied by the target object within the 3D point data based on the 3D point data and the 2D image data.

24. The method of claim 23, further comprising analyzing the 2D image data utilizing a plurality of neural network models, wherein the plurality of neural network models are configured to generate respective 2D bounding boxes for the target object based on the 2D image data.

25. The method of claim 24, wherein the plurality of neural network models are further configured to generate respective object classifications for the target object based on the 2D image data.

26. The method of claim 24, further comprising generating a final bounding box based on the respective 2D bounding boxes of the plurality of neural network models.

27. The method of claim 26, further comprising generating the final bounding box based on an overlapping area between two or more of the respective 2D bounding boxes of the plurality of neural network models.

28. The method of claim 27, further comprising generating the final bounding box based on a deviation of the two or more of the respective 2D bounding boxes of the plurality of neural network models from the overlapping area.

29. The method of claim 27, wherein the neural network models comprise respective model bias scores, and
wherein the method further comprises generating the final bounding box based on the respective model bias scores of the plurality of neural network models.

30. The method of claim 23, further comprising:
analyzing the 2D image data to detect a second object, different from the target object, and
detecting whether the target object is a neighbor of the second object without a third object therebetween.

31. The method of claim 30, further comprising determining whether the third object occludes a portion of the target object.

32. The method of claim 31, further comprising adjusting the predicted volume of the target object based on whether the target object is occluded by the third object.

33. The method of claim 23, further comprising:
determining a predicted 2D bounding box for the target object based on the 2D image data;
determining neighbor relationship data based on a relative location of a plurality of objects in the 2D image data with respect to the target object; and
determining the predicted volume occupied by the target object within the 3D point data based on the predicted 2D bounding box and the neighbor relationship data.
